(19) United States
(12) Patent Application Publication
(10) Pub. No.: US 2014/0309967 A1
(43) Pub. Date: Oct. 16, 2014

(54) Method for Source Identification from Sparsely Sampled Signatures

(71) Applicants: Thomas Eugene Old, Santa Barbara, CA (US); Neal Jay Carron, Santa Barbara, CA (US); Scott Mark Frasier, Santa Barbara, CA (US); John Christopher Baker, Santa Barbara, CA (US)

(72) Inventors: Thomas Eugene Old, Santa Barbara, CA (US); Neal Jay Carron, Santa Barbara, CA (US); Scott Mark Frasier, Santa Barbara, CA (US); John Christopher Baker, Santa Barbara, CA (US)

(21) Appl. No.: 13/862,311

(22) Filed: Apr. 12, 2013

(51) Int. Cl. G06F 17/18

(52) U.S. Cl. CPC G06F 17/18
USPC 702/181

(57) ABSTRACT

The present invention relates to the method to identify the source of a signature signal by processing sparse digital data collected by a sensor system in a laboratory, field, or other application. The invention specifically addresses weak, obscured, or partially sampled signatures collected by a sensor system. The method takes advantage of all sources of data using an innovative method that uses Bayes Theorem for performing probability arithmetic and statistical inference. The method requires an exclusive and exhaustive library of candidate signatures. The method finds the most likely signature candidate from the library that has the highest likelihood of being responsible for the measured signal. In addition, the method can work with mixtures of library candidates to find the most likely mixture that explain the data. The method is applicable to a variety of sensor systems that collect and digitize data as signal strength (ordinate) versus measurement attribute (abscissa).

### CROSS REFERENCE TO RELATED APPLICATIONS

Priority is claimed from U.S. provisional patent application Ser. No. 61/623,777, filed Apr. 13, 2012, entitled “Sparse Signature Identification Algorithm”, the entire disclosure of which is incorporated by reference herein.

### OTHER REFERENCES

E. T. Jaynes, “Bayesian Methods: General Background.” In Maximum-Entropy and Bayesian Methods in Applied Statistics, by J. H. Justice (ed.). Cambridge: Cambridge Univ. Press (1986).
T. Loredo, The Promise of Bayesian Inference for Astrophysics, http://www.astro.cornell.edu/staff/loredo/bayes/promise.pdf.
T. Loredo, From Laplace to Supernova SN 1987A: Bayesian Inference in Astrophysics, http://bayes.wustl.edu/gregory/articles.pdf.

### BACKGROUND OF THE INVENTION

The present invention relates to the processing of digital signature data collected by a sensor system in a laboratory, field, industrial, or other application to obtain a high confidence identification of the signature of interest. The data processing method specifically addresses cases where the sensor collects a less than optimal signature due to low amplitude of the signal with respect to background, incomplete or missing features or attributes of the entire signature, high levels of clutter in which the signature is buried, or other limited time or exposure collection cases, yet is still able to identify the signature of interest if it is present. In all cases, the signature of interest is weak, obscured, or partially sampled as collected by a sensor system. Often, the signature presents a challenge due to the distance of the sensor to the signature source, or the sensor takes a rapid collection that does not allow a complete signature to be acquired. These data can consist of an amplitude versus time series, an optical or energy spectrum, or any other data series that represents a one dimensional data set that is typically graphed as ordinate against abscissa when displayed. The result is an identification of the signal signature along with a confidence factor as to whether the signal identification is correct.

Methods used to analyze signatures in order to identify the source of the signatures typically consist of feature extraction and identification, by use of pattern matching, matched filtering, linear regression, or other similar methods. All rely on a data set containing a large number of samples that fully populate the time series or spectrum with plentiful data points.

In the sparse signature case, which we address here, these alternative methods of processing data can be limited in functionality, and effectiveness, when dealing with these weak signals of interest that suffer from very low signal to noise level. Processing methods can fail due to the conditions of the collection environment, the source signal strength, the sensor responsivity or overall effectiveness, or other factors. Prior methods typically fail to detect, or as importantly correctly identify, the signal of interest. Then, the processing method can fail to assign a confidence to the signal identification. Various signal processing methods and software packages are available from a variety of commercial and other sources to aid in sensor signature processing.

This method can be applied to several technology areas. In the gamma isotope identification application, it excels in identifying the gamma ray emission source with few counts, typically when only a small fraction of all counts is due to the source. Such a situation is common, for example for a distant source, or one that can be measured for only a short time. The data analysis methods are a significant improvement over existing State of the Art, and yet are based on well-founded principles. It is the purpose of the current invention to overcome these shortfalls in successfully identifying the signal source with a defined confidence level, to be applicable to a variety of sensors and signatures, and to be flexible and extendable to many applications.

### BRIEF SUMMARY OF THE INVENTION

The SSI Method applies to the field of signal processing of sparse signatures. The method is specifically designed to overcome the shortfalls of conventional analysis methods which are ineffective when the source of interest is weak, provides a minimally populated distribution, is distant, and/or is buried in background.

The SSI method is not a peak finding, spectrum deconvolution, or matched filtering approach that is commonly used in sensor signature identification. To identify sparse signatures, SSI utilizes a statistical approach based on methods developed and refined in this SSI method.

Using state-of-the-art statistical methods, the SSI method determines the probability that the source in the data was one of the possible members of its source library. Almost always, one source is significantly more probable than all others, and an identification decision is made. Sometimes two or more library sources have comparable probabilities. In that case, to make a determination, one takes into account any additional information one may have about probable sources.

Various sensor systems that collect digital data can make use of the SSI Method. For example, these sensors collect data such as optical spectra by wavelength, acoustic spectra by frequency, ionizing gamma ray radiation by energy, or other phenomena quantized by the sensor and stored as a digital data file in a format of signal amplitude and channel. The SSI method is configured and optimized for the sensor and signals of interest through its input library of possible sensor-specific source signatures.

The sensor's measurement typically consists of the signal of interest mixed with background. These can exist at various signal and background strengths, and exist at various ratios with respect to each other in the measurement. The measurement is captured by the sensor instrumentation system and stored as a digitized data file. The data can comprise one dimensional digital information, such as from a conventional electronic spectrum analyzer, or two dimensions, such as from a camera system, or more dimensions, such as a series of time-sequenced snapshots from a camera system. In each case, the sensor's collected signal is binned into distinct channels and quantized into individual measurements per channel. An example, for a gamma ray radiation source identification implementation of the SSI Method is shown in FIG. 1

The current SSI data processing method invention is optimally configured to identify a signal of interest that is challenging to identify, due to the fact that the signal is weak and is buried in its background, or sufficiently similar to or buried by other clutter, making it difficult to extract the signal identification or other characterizations.

### BRIEF DESCRIPTION OF THE DRAWINGS

FIG. 1 Block Diagram of a sensor system configuration that would employ the SSI Method.

FIG. 2 Block diagram of the SSI Method signal processing flow.

FIG. 3 The sensor and source general measurement scenario.

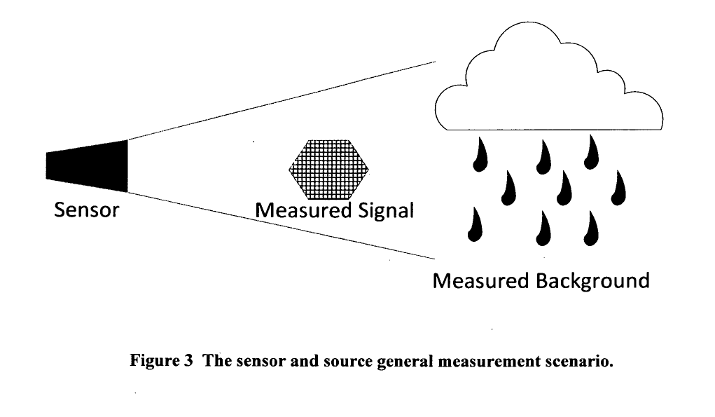

FIG. 4 Monte Carlo Simulation of Inference Methodology.

FIG. 5 CZT instrument function normalized covariance matrix.

FIG. 6 CSI instrument function normalized covariance matrix.

FIG. 7 The source PDF versus arrival rate for total counts minus background.

FIG. 8 The background PDF versus arrival rate.

FIG. 9 The background+2*sigma PDF versus arrival rate.

FIG. 10 Joint Probability Venn diagram.

FIG. 11 Definitions of counting times and number of counts.

FIG. 12. Source mean count rate distribution when background is known.

FIG. 13. Same as FIG. 12 but with background counts of 600 cts/sec.

FIG. 14. Chi sub I on the same graphs as FIG. 12, with p(s).

FIG. 15. Chi sub I on the same graphs as FIG. 13, with p(s).

FIG. 16. SSI Method results for a mixture of two sources.

FIG. 17. An example of two isotope mixture probability vs Mixture Percentage.

FIG. 18. An example plot of the probability of each isotope pair combination (indices 1 to 66) for every pair in the library.

FIG. 19. Example of three dimensional plot of probability of all mixture pairs and mixture percentages.

### DETAILED DESCRIPTION OF THE INVENTION

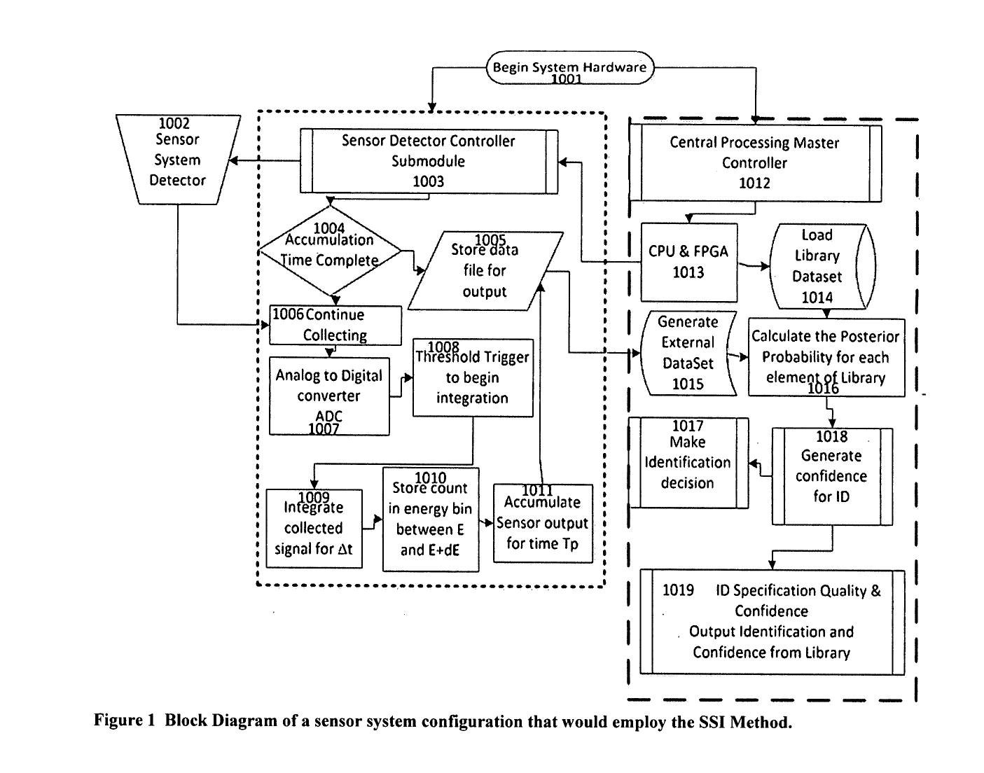

The current invention, the Sparse Signature Identification (SSI) Method, is designed to analyze sparse data (with poor sampling statistics) that is collected by a sensor system and determine the appropriate observed source candidate or candidates from which the signature came. The SSI Method can be resident, or embedded, in the sensor instrument for real time implementation, or can be placed on a computer, smart phone, or other processing system tasked to process the off-loaded sensor data at a later time as shown in FIG. 1 for a radiation signature identification embodiment.

The current SSI data processing invention is optimally configured to identify a signal of interest that is challenging to identify, due to the fact that the signal is weak and is buried in its background, or sufficiently similar to or buried by other clutter, making it difficult to extract the signal identification or other characterizations.

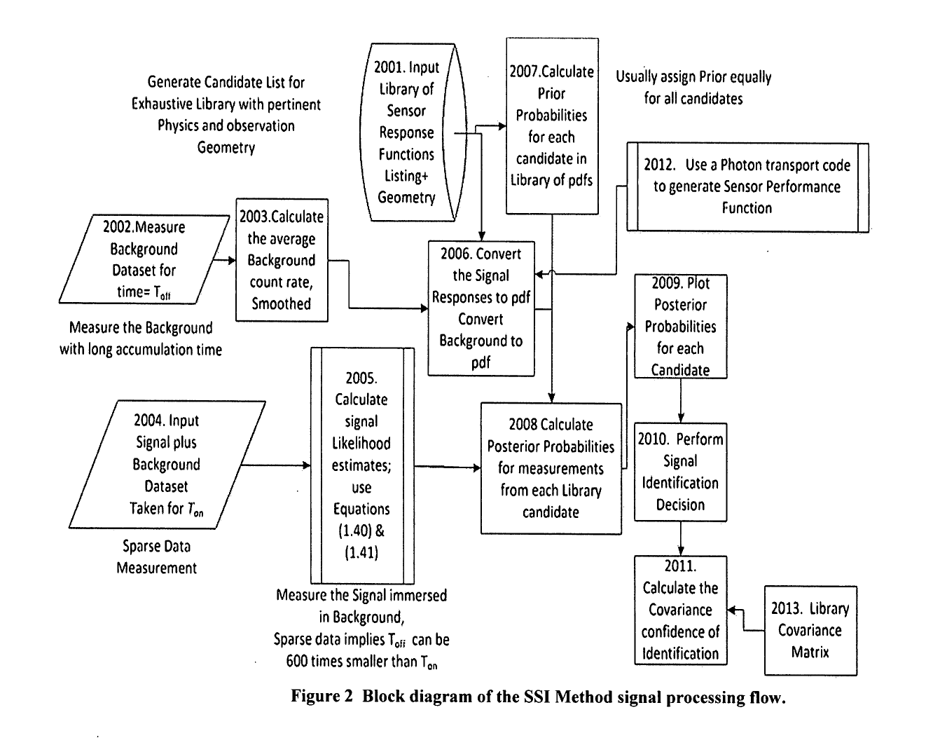

The SSI Method comprises distinct elements that enable the input signal to be processed for signal extraction and proper identification. The SSI Method process steps are shown in FIG. 2 and described below.

The invention described here determines the probability that a measurement comes from a limited and exhaustive library of candidates. It uses all knowledge available to estimate the probability of a library candidate. Bayes Theorem is used to introduce additional information into the probability calculation.

This invention applies to sparse statistical measurements. The method has wide applicability across a broad technology base of estimates from various types of measurements. As an application example, we describe the SSI method use in extracting identifications of radioactive isotopes from radiation spectrometer spectral signature measurements. This example consists of gamma photons detected as counts at given gamma energy bins, as represented in a two dimensional discrete distribution. Similarly, the SSI Method could be applied to a wider technology base and signature phenomenology.

Without loss of generality and as a concrete example of the invention technology area, the invention applies to identification of gamma radiation emitting isotopes, where a pulse height histogram in energy is measured from the background plus the isotope signature. Many techniques have been invented to address the identification problem when there are many gamma ray counts in the measured spectrum, i.e. there may be millions of counts and very good emission signal to background noise. These methods such as peak finding, spectrum unfolding, principal component analysis, partial least squares, null hypothesis significance tests and others were found to fail when the signal counts are sparse. The SSI method is addressing the problem of less than 1000 measured gamma rays in a data collection, including both signal plus background. The signal may be less than 15 counts out of total captured counts with a signal to noise ratio of less than 1.

To make our process perform high confidence isotope identification from the spectrum signature, we need to limit our possible candidates to an exclusive and exhaustive set, one of which is the background. Secondly, we need to measure the background very accurately over long time period, i.e. with very good count rate statistics. This background library element can also be estimated from semi-empirical techniques. The error in the library background candidate will be small.

The isotope spectral measurements can be calculated using high fidelity code or measured in the laboratory over long counting times. The library spectra of each isotope will represent the signal spectral (pulse height versus energy bin) content from a pure element with no background and no noise. To create the library spectra requires a detailed understanding of the sensor performance when measuring the spectrum. Comprehensive and accurate sensor performance models are available to generate the library. These models are calibrated and validated against laboratory measurements. These calculations and measurements can be normalized to a probability density function for each isotope candidate in the library. The library consists of probability density distributions for each library isotope. It is the probability of a gamma being detected by a specific sensor for the bin number of interest. From this information we can calculate the most likely probability that the isotope emitting the gamma ray came from one or more of the library candidates.

In the sparse count rate measurements, the signal plus background can be less than the measured background, even if there is a signal present. The collected spectral histogram measurement, when plotted, looks like a picket fence instead of a continuous spectrum. Peak finding techniques fail with this kind of data since every bin looks like a peak.

The SSI method process first calculates the probability of each isotope from the library. From this data, an identification inference is made, as a distinct sub-process of the methodology. Currently, the signature inferred is the most probable element in the library.

This Section discusses a methodology for inferring a signature ID from a set of measured data. The SSI method uses each count in the histogram bins and Bayes' Theorem to update a prior likelihood distribution of possible sources, using the set of measured data. The result is a posterior likelihood distribution of possible sources, which will represent an improvement over the prior distribution.

This is a specific implementation example of the SSI Method to identifying a radiation source from its spectral measurements.

The SSI method comprises distinct elements that enable the input signal to be processed for signal extraction and proper identification. The SSI method elements are shown in FIG. 2 and described below. The key elements of the SSI method shown in FIG. 2 are:

(Block 2001) is a library of known sensor instrument response measurements of possible signals of interest to be identified. These are library candidate signatures that span an exclusive and exhaustive set of possible signatures that the sensor may collect. These signatures could be generated from the specific sensor where very long collection times or high count rates are imposed. The library generated from these measurements has the known statistically significant background subtracted. For example, in radiation measurements, the instrument may collect tens of thousands of counts across the energy spectrum for both the library isotope gamma emission and the background. The background can then be removed from the measured signal plus background.

In addition, a detailed high fidelity model can be employed to generate the expected signal under specific experimental conditions including such ionizing radiation effects as ground scatter, instrument scatter, internal scatter, particle creation and annihilation, back scatter and other high fidelity phenomenon. These measurements and modeled calculations are the basis for building the library of candidates that may be responsible for a given sparse signature from the unknown source. The datasets are then normalized to consist of probability density distributions of expected library measurements.

(Block 2002) is a background data set, without any of the library signatures of interest; this measurement is available for the method to use. This background data set is collected by the sensor of interest, or is carefully modeled based on the known high fidelity response characteristics of the sensor and a very well-known background. This input is an individual digital data set for the likely background that is part of the unknown source signature of interest, which consists of signal plus the background. It is in a format consisting of measurements across distinct system parameters such as count rate per energy or time bin. This background is collected for T_{off} seconds which can be very long compared to the short time of sparse signal plus background measurement of the unknown signature. The method accumulates the background (Block 2003) data when signal is not present to provide a statistically robust average background rate to be used when background and signal are present in a measurement.

The method accumulates the background (Block 2003) data when signal is not present to provide a statistically robust average background rate to be used when background and signal are present in a measurement.

(Block 2004) is the measurement of the unknown signature of interest immersed in the well-characterized background measured from (Block 3). This measurement is the sparse distribution over parameter space to be analyzed by the SSI method. This measured signature is captured and stored by the sensor in a digital data set, in a format consisting of a distribution of count rate per parameter bin, similar in nature to a histogram

Inferring the identity of the signature from the measurement is an inverse process.

Inference is determined by using the known instrument response library, where each library element is a probability density distribution for that library element (Block 6), and its most likely comparison to the signal measurement in background. The SSI method will determine the most likely candidate of the measurement to the library elements using a Bayesian process on the likelihood distributions.

In order to determine which library candidate (Block 2001) is present in the measurement, the SSI method uses the library member probability density distributions for each library candidate member. The SSI method uses prior probabilities (Block 2007) for each candidate library member to be incorporated into the most likely probability (Block 2008) calculation. The prior probabilities are based on possible known information about the presence of a library member responsible for the signal. The SSI method performs posterior probability calculations based on a unique combination of Bayesian conditional probability methods.

The SSI method outputs the posterior probabilities for each library member (Block 2009) as being present in the measurement. A plot of this output can be represented in a probability versus candidate graph, a histogram-like bar chart, or other graphical display showing the most likely candidate identification compared to probabilities from all other library elements.

Based on posterior probability results, the SSI method makes a decision (Block 2010) of which library candidate member (Block 2001) is present in the signature measurement. The decision process can have many levels of complexity. For example, the decision can be based on the SSI method's absolute value of maximum probability amplitude for a given library element, or the relative probability amplitude relationships among candidate members, or some other relative relational criteria. The decision process can take into account a priori information about the signal of interest.

In order to quantify the confidence, or quality of library signature identification, the SSI method uses a covariance matrix (Block 2010) between all library candidate members to assess the distinctness of the candidate's identification process. This enables the method user to assess various outcome likelihoods in order to establish confidence in the final answer.

In the following paragraphs, we define the various energy distribution functions that will be referenced in the subsequent SSI source identification inference discussion.

The signal source distributions observed by the sensor consist of a series of lines with relative strengths, {Lᵢ}, plus a continuum, C(E),

$$S ( E ) = {\sum }_{i = 1}^{{N}_{S}} {L}_{i} \cdot δ ( E - {E}_{i} ) + C ( E ) . \qquad ( 1.1 )$$

A normalized source distribution satisfies the following constraint:

$${\sum }_{i = 1}^{{N}_{s}} {L}_{i} + \int C ( E ) d E = 1. \qquad ( 1.2 )$$

The sensor detected response distribution, D(E_{R}|S_{S}, resulting from a source distribution S(E_{S}) and detector response R(E_{R},E_{S}) is

D(E_{R}|S)=∫R(E_{R},E_{S})·S(E_{S})dE_{S}. (1.3)

The sensor instrument response distribution, Λ(E_{I}|S), results from a convolution of the instrument error function, Δ(E_{I},E_{R}), with the detected response, D(E_{R}|S_{S}),

$$\begin{matrix}Λ ( {E}_{I} \vert S ) = \int Δ ( {E}_{I} , {E}_{R} ) [ \int R ( {E}_{R} , {E}_{S} ) \cdot S ( {E}_{S} ) d {E}_{S} ] d {E}_{R} \\ = \int S ( {E}_{S} ) [ \int Δ ( {E}_{I} , {E}_{R} ) \cdot R ( {E}_{R} , {E}_{S} ) \cdot d {E}_{R} ] d {E}_{S} .\end{matrix} \qquad ( 1.4 )$$

The sensor instrument response Λ(E_{I}|S) is proportional to the relative likelihood that a count with energy E_{I} will be measured if the instrument response function is Λ(E|S):

P(E|Λ)∞Λ(E|S). (1.5)

The proportionality constant is the detector efficiency for observed source S.

The instrument-detected, background distribution, B(E_{I}|S_{Background}), is a particular instrument response distribution to an unknown background source, S_{Background}. Equation (1.4) relates S_{Background} and B(E_{I}|S_{Background}).

A measured data set, M(E|S), obtained by measuring the response of a radiation detector sensor to a set of incident photons, {E_{S}[i]}, represented by source distribution S(E_{S}). The result is a set of counts, {mᵢ}, in a designated set of measurement N_{B} bins, {Θᵢ=Θ(E_{B}[i])}, with widths, {ΔE_{B}[i]}. The bin histogram for this data set is

$$M ( E \vert S ) = {\sum }_{i = 1}^{{N}_{B}} {m}_{i} \cdot Θ ( {E}_{B} [ i ] ) \qquad ( 1.6 )$$

where the bin function is

$$Θ ( E , {E}_{B} [ i ] ) = \{ \begin{matrix}\frac{1}{Δ {E}_{B} [ i ]} & - \frac{Δ {E}_{B} [ i ]}{2} < ( E - {E}_{B} [ i ] ) \leq \frac{Δ {E}_{B} [ i ]}{2} \\ 0 & Otherwise\end{matrix} . \qquad ( 1.7 )$$

Inferring the identity of the observed source from the sensor measurements is an inverse process. We start with a set of measurements {Eᵢ} and wish to determine which sensor instrument response is the most likely source. Ideally, sensor instrument response is related one-to-one to the source, although the sensitivity varies.

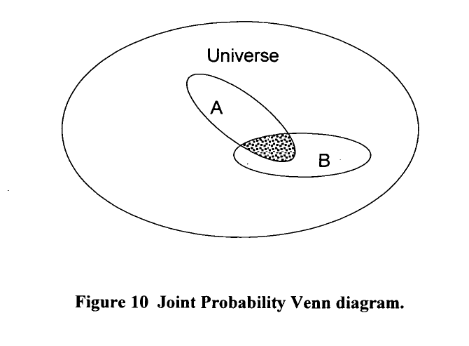

The joint probability density P(E,Λ) for two random variables E and Λ as shown in a cross hatched area of the Venn diagram in FIG. 10, is related to the conditional and single-variable distributions by the following:

P(E|Λ)P(Λ)=P(E,Λ)=P(Λ|E)P(E) (1.8)

Equation (1.8) is known as Bayes' Theorem. The Bayes' Theorem is a well-established tool relating conditional probabilities. Equation (1.8) mathematically relates the conditional probabilities P(Λ|E) and P(E|Λ) for two variables \tilde{E} and \tilde{Λ}. It allows one to infer one of these conditional probabilities from the other, if the single-variable probability density functions P(E) and P(Λ) are known.

For a set of distributions {Λₖ} and a set of measured energies {Eᵢ: i=1, M} one can infer the first revision of the likelihood for the distribution Λⱼ, conditioned the measured energy Eᵢ, using

$$P ( {Λ}_{j} \vert {E}_{i} ) = \frac{P ( {E}_{i} \vert {Λ}_{j} ) P ( {Λ}_{j} )}{P ( {E}_{i} )} = \frac{P ( {E}_{i} \vert {Λ}_{j} ) P ( {Λ}_{j} )}{{\sum }_{\{ {Λ}_{k} \}} P ( {E}_{i} \vert {Λ}_{k} ) P ( {Λ}_{k} )} \qquad ( 1.9 )$$

where {P(Λₖ)} are the prior likelihoods of the distributions {Λₖ} and {P(Eᵢ)} are the prior likelihoods of the set of measured energies. The prior likelihoods for the energies are the most problematic because one would need to measure energy detections for all possible sources, in their proper proportion. However, the estimated P(Eᵢ) used in each application of the inference is

$$P ( {E}_{i} ) = {\sum }_{\{ {Λ}_{k} \}} P ( {E}_{i} \vert {Λ}_{k} ) P ( {Λ}_{k} ) \qquad ( 1.10 )$$

which is just the required normalization for {P(Λⱼ|Eᵢ)}.

One can continue to apply this Bayesian inference procedure for the rest of the measured energies in the set {Eᵢ: i=1, M}. The formal statement of these M applications is

$$P ( {Λ}_{j} \vert \{ {E}_{i} \} ) = [ {\prod }_{i = 1}^{M} \frac{P ( {E}_{i} \vert {Λ}_{j} )}{P ( {E}_{i} )} ] \cdot P ( {Λ}_{j} ) \qquad ( 1.11 )$$

which is just the product of the marginal likelihoods of measuring Eᵢ on condition that the instrument distribution is Λⱼ. At the application of Bayesian inference, the prior likelihoods used calculation of the posterior distributions {P(Λ_{z}|{E_{z}:l=1, i−1})} that resulted from the previous i−1 applications of Bayesian inference.

After each measured energy has been used as shown in Equation (1.11), one has revised estimates of the likelihoods that the set of measured energies represent samples of the instrument distributions {Λₖ}. Note that the posterior likelihoods are proportional to the priors, so one must evaluate the sensitivity of Bayesian inference to the choice of priors in the specific application.

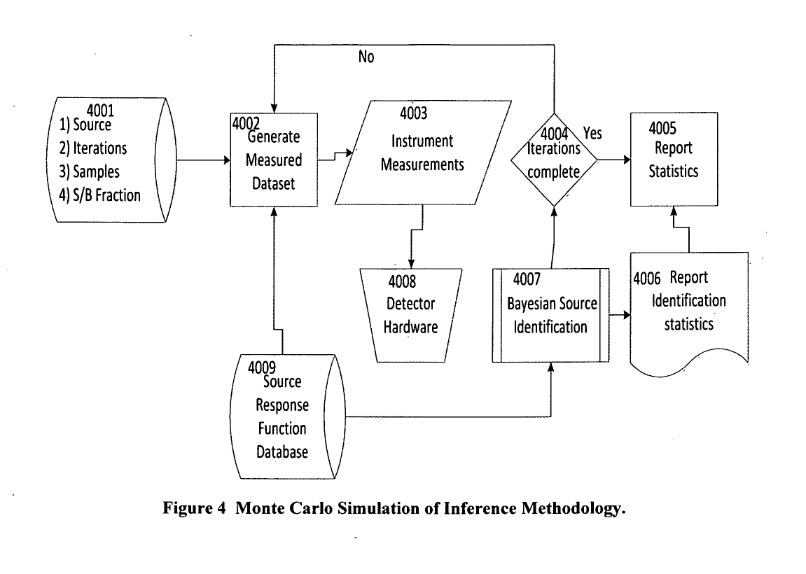

To test the effectiveness of the SSI method inference in distinguishing sources, a Monte Carlo simulation of the SSI method has been developed. To simplify the SSI Monte Carlo implementation shown in FIG. 4, all sensor instrument response functions have been sampled uniformly every 1 keV in energy, and the sensor energy bins have been chosen to be 1 keV wide as well.

The Monte Carlo detector responses {Eᵢ: i=1, M} are created by randomly sampling the cumulative source plus background response. The linear combination of the source and background responses is determined by a specified source fraction, s, and a background fraction, b=1−s.

$${C}_{s} ( {E}_{i} ) = {\int }_{0}^{{E}_{i}} P ( E \vert s {Λ}_{s} + b {Λ}_{b} ) d E = {r}_{i} , i = 1 , M \qquad ( 1.12 )$$

The simulated detector events obtained by sampling the source/background distributions consists of M counts that are distributed across M or fewer bins. The detector source identification processing consists of applying the inference of Equation (1.8), successively for each count, for a collection of candidate source/background distributions.

If one restricts the problem to identifying single isotope sources, the candidate distributions are linear combinations of the background and each of the sources individually. The weight of the background is assume to be the current background estimate b̅, and that for each of the source candidates is assumed to be s̅=1− b̅. The posterior likelihood of each candidate Λⱼ is inferred using:

$$P ( \overline{s} {Λ}_{j} + \overline{b} {Λ}_{b} \vert \{ {E}_{i} \} ) = [ {\prod }_{i = 1}^{M} \frac{P ( {E}_{i} \vert \overline{s} {Λ}_{j} + \overline{b} {Λ}_{b} )}{P ( {E}_{i} )} ] \cdot P ( \overline{s} {Λ}_{j} + \overline{b} {Λ}_{b} ) . \qquad ( 1.13 )$$

After all of the posterior likelihoods are obtained for a given event using Equation (1.13), the most likely source candidate is chosen as the source for that event. This process is repeated for a series of generated events, after which the distribution of chosen sources is reported. Additional statistics are collected on the estimated likelihoods for the candidate sources.

This section provides a measure of the ability of the SSI inference method to distinguish between sets of possible instrument functions.

A measure of the distinctness of the response functions can be calculated by considering the covariance matrix of the sensor instrument response functions {P(Eᵢ|Λₖ)}

σₖₗ²=∫P(E|Λₖ)·P(E|Λₗ)dE. (1.14)

This quantity is per unit energy dE, which is small relative to the resolution of the sensor instrument functions. The magnitude of the σₖₗ² signifies the extent to which the prominent features of the two instrument functions coincide in the energy continuum.

Qualitatively, the magnitude of the diagonal element σₖₖ² signifies the extent to which the instrument functions P(E|Λₖ) is resolved into sharp peaks. An instrument function that is highly resolved and that consists of relatively small number of features will produce a larger σₖₖ² than one that is more poorly resolved or that contains many distinct peaks.

The normalized covariance matrix whose elements can be defined by

$${ρ}_{kl}^{2} ≡ \frac{{σ}_{kl}^{2}}{{σ}_{k} {σ}_{l}} . \qquad ( 1.15 )$$

The diagonal elements are all equal to unity. The off diagonal elements indicate the extent to which the corresponding instrument functions have significant responses at the same energies. Two instrument response functions with significant overlapping responses are more difficult to distinguish, and it is expected that more counts will be required before a decision can be made confidently.

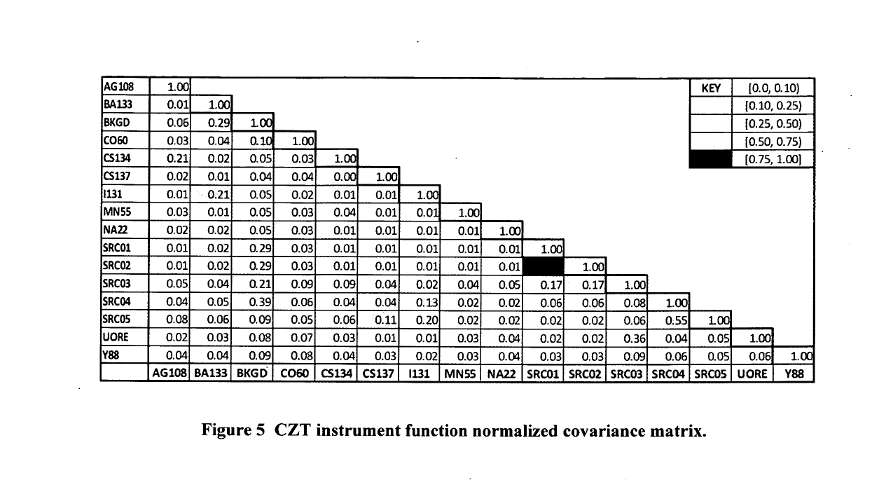

FIG. 5 shows a normalized covariance matrix {pₖₗ²} for a nominal collection of instrument responses in a cadmium zinc telluride (CZT) radiation detector. The cells are shaded to indicate the extent of response overlap between the response functions. The darker shade indicates a closer match between two library candidates. Most of the normalized covariance values are small. The major exception is that between sources SRC01 and SRC02.

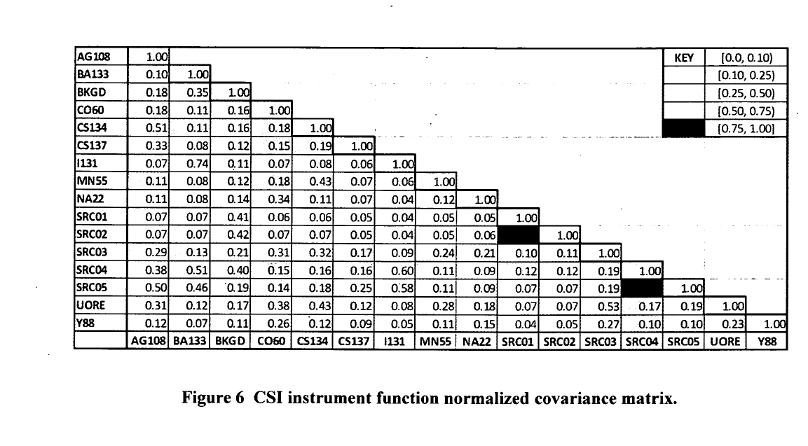

FIG. 6 shows the normalized covariance matrix for the same sources for a CSI radiation detector response function. The poorer energy resolution of CSI with respect to CZT, along with the larger Compton background due to detector properties, result larger instrument function overlaps. This larger overlap makes the instrument functions less distinguishable from one another given the same number of counts.

This Section shows derivation of a distribution of a Poisson source count rate based on measurements of N_{b} counts over a time interval T_{b} and N_{bs} source and background counts measured over a time interval T_{bs}.

The Poisson Probability Distribution, PDF, for detecting N counts during a time interval T from a source that produces an average count rate r is

$$p ( r , N , T ) = \frac{{T ( rT )}^{N}}{N !} exp ( - rT ) \qquad ( 1.16 )$$

The Poisson PDF applies to the background, source, and the combination so, in particular, the source and source plus background cases described above obey

$$p ( b + s , {N}_{bs} , {T}_{bs} ) = \frac{{{T}_{bs} ( \vert b + s \vert {T}_{bs} )}^{{N}_{b}}}{{N}_{bs} !} exp ( - \vert b + s \vert {T}_{bs} ) , \vert b + s \vert \geq 0 \qquad ( 1.17 )$$

For the general case of arbitrary N_{b} and N_{bs}, a conditional PDF for can be derived from

p(s|N_{bs},T_{bs},N_{b},Tₛ)=∫p(b+s,N_{bs},T_{bs})p(b,N_{b},T_{b})db (1.18)

Equation (1.18) can be evaluated by expanding term and performing the b integration term by term.

In the limit of the known background rate case of Nb>>Nbs, we can consider the background probability density function (PDF), p(b,N_{b},T_{b}) to be approximated by a Gaussian with a peak located at

$$\overline{b} \approx \frac{{N}_{b}}{{T}_{b}}$$

and a variance of σ²=N_{b}.

$$p ( {n}_{b} = {bT}_{b} , {N}_{b} ) db \approx \sqrt{\frac{1}{2 π {N}_{b}}} {T}_{b} exp [ \frac{- {( {bT}_{b} - {N}_{b} )}^{2}}{2 {N}_{b}} ] db = \sqrt{\frac{1}{2 π {N}_{b}}} exp [ \frac{- {( {n}_{b} - {N}_{b} )}^{2}}{2 {N}_{b}} ] {dn}_{b} \qquad ( 1.19 )$$

Equation (1.19) then reduces to

$$p ( s \vert {N}_{bs} , {T}_{bs} , {N}_{b} , {T}_{s} ) = \sqrt{\frac{1}{2 π {N}_{b}}} {\int }_{0}^{∞} p ( [ \frac{{n}_{b}}{{T}_{b}} + s ] {T}_{bs} , {N}_{bs} ) exp ( \frac{- {[ {n}_{b} - {N}_{b} ]}^{2}}{2 {N}_{b}} ) d {n}_{b}$$

$$p ( s \vert {N}_{bs} , {T}_{bs} , {N}_{b} , {T}_{s} ) = \sqrt{\frac{{N}_{b}}{2 π}} {\int }_{0}^{∞} p ( [ v \overline{b} + s ] {T}_{bs} , {N}_{bs} ) exp ( \frac{- {{N}_{b} [ v - 1 ]}^{2}}{2} ) d v$$

For Nᵥ>>N_{bs}, the Gaussian over v becomes effectively δ(v−1)

$$p ( s \vert {N}_{bs} , {T}_{bs} , {N}_{b} , {T}_{s} ) = p ( \overline{b} + s , {N}_{bs} , {T}_{bs} ) \approx \frac{{{T}_{bs} ( ( \overline{b} + s ) {T}_{bs} )}^{{N}_{bs}}}{Γ ( {N}_{bs} + 1 , \overline{b} {T}_{bs} )} exp ( - ( \overline{b} + s ) {T}_{bs} ] \qquad ( 1.20 )$$

where the domain for s is (0, ∞) and Γ(N_{bs}+1, b̅T_{bs}) is the upper incomplete gamma function.

For N_{bs}>>1, p( b̅+s, N_{bs}T_{bs}) is approximated well by a Gaussian centered on

$${s}^{⋒} = \frac{{N}_{bs}}{{T}_{bs}} - \overline{b}$$

(the peak value), so

$$p ( s \vert {N}_{bs} , {T}_{bs} , {N}_{b} , {T}_{b} ) \approx \frac{{T}_{bs}}{C ( {s}^{⋒} {T}_{bs} , {N}_{bs} ) \sqrt{{N}_{bs}}} exp [ \frac{- {{T}_{bs}^{2} ( s - {s}^{⋒} )}^{2}}{2 {N}_{bs}} ] ds , s > 0 \\ C ( {s}^{⋒} {T}_{ba} , {N}_{bs} ) ≡ \frac{\text{?}}{\sqrt{{N}_{bs}}} exp [ \frac{- {v}^{2}}{2} ] d v \\ \text{?} \text{indicates text missing or illegible when filed} \qquad ( 1.21 )$$

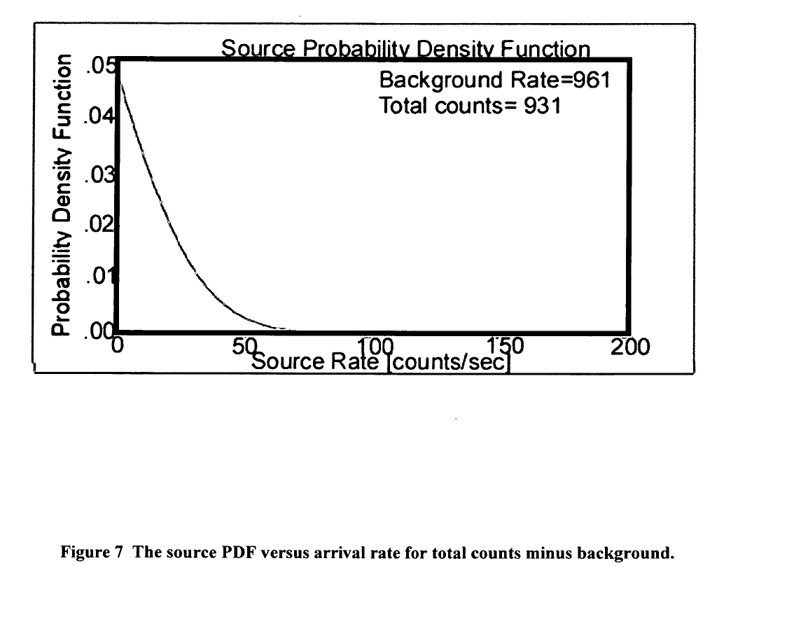

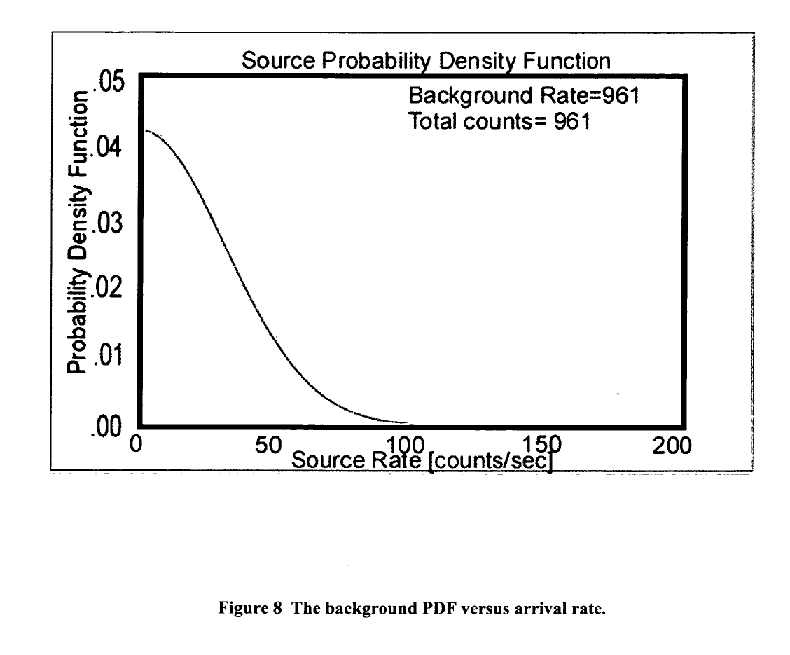

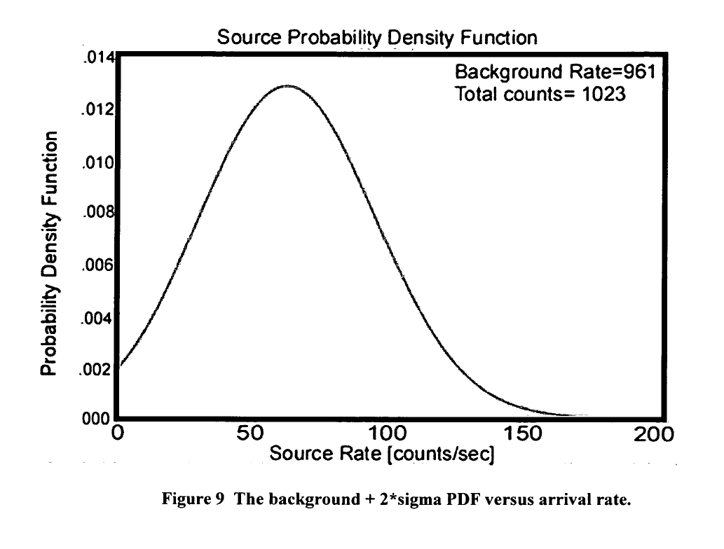

FIGS. 7, 8, and 9 show the source rate distributions for a radiation detector background of 961 counts per second (cps) and a (source+background) of 931, 961, and 1023 counts, respectively, measured over a 1 second interval. For these count totals, the source distributions are well-approximated by Gaussian distributions centered at −31, 0, and 62, respectively.

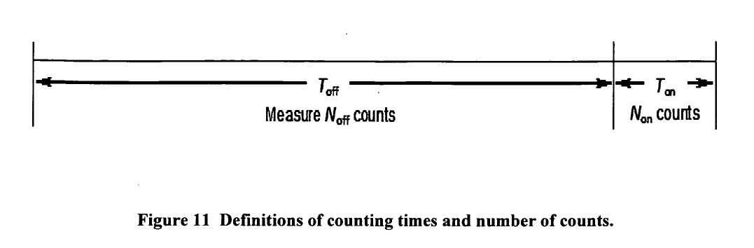

This section describes the background determination methodology. A common problem is measuring a weak source in a strong background. The background is measured separately (“Off-source”) for a time T_{off} obtaining N_{off} counts. The source-plus-background is measured for a time Tₒₙ (“On-source”) obtaining Nₒₙ counts. This is shown in FIG. 11.

Since the source of interest is weak, to obtain the number of counts that can be attributed to the source, it is dangerous to “subtract background” from the on-measurements. Poisson fluctuation means the result can be negative. Yet we still desire to infer information about the source from the measurements.

We obtain the exact probability that in the Nₒₙ counts the number of source counts is i (i=0, 1, . . . Nₒₙ). The answer is Cᵢ, Eq (1.40), or its alternate form (1.44). It is valid for arbitrary numbers of counts N_{off} or Nₒₙ, and arbitrary times T_{off} or Tₒₙ. The derivation makes use of the Poisson distribution of the number of counts in a fixed time interval, but the resulting distribution Cᵢ is not Poisson.

This is precisely the problem often faced by astronomers and astrophysicists, and is referred to as the “On/Off Problem”.

A simpler formula holds when background is measured for a long time, so that the mean background count rate b can be considered known. We obtain the probability p(s) that the mean source count rate is s, and the probability x, that the number of source counts is i.

It is assumed that mean photon arrival rates, and their count rates, are constant over T_{off} and over Tₒₙ. For measurement scenarios that the SSI method addresses, such as transient sources or a rapidly moving source, that assumption may not be true, depending on measuring times. The collection times of the signal plus background and background only is shown in FIG. 11.

First consider a general radiation source, presenting gammas to a detector and producing a steady mean count rate r (cts/s). In time T the mean number of counts is m=rT. The probability that the detector counts n is the usual Poisson distribution

$$P ( n \vert m ) = P ( n \vert r , T ) = \frac{{m}^{n}}{n !} {e}^{- m} = \frac{{( rT )}^{n}}{n !} {e}^{- rT} \qquad ( 1.22 )$$

As before, P(x|y) is the probability of x given y. Eq (1.22) is the probability that the actual number of counts during T is n when the mean m is known, or, equivalently, when the mean count rate r is known.

But one may have the opposite problem. We know only T and a measured number n. It is useful to determine the mean rate r, or the mean number m=rT. So we must infer r from n and T. Of course there is no single r. Given n and T, there is a probability distribution for values of r; we seek that distribution. The result, Eq (1.25), will be used later.

To do this, use Bayes' Theorem for the probability P(r|n,T) that the rate is r, in terms of a prior P(r) and the likelihood function P(n|r,T) [which is just the Poisson Eq(1.22)],

$$P ( r \vert n , T ) = P ( r ) \frac{P ( n \vert r , T )}{P ( n )} \qquad ( 1.23 )$$

As noted earlier, probabilities written here as P(r) or P(n) are conventionally written as P(r|I) or P(n|I), where I is generic information at hand. We use the simpler notation, leaving I understood.

We need the prior P(r) which can be equally probable for every r, i.e. flat. The Bayesian justification for this is that a flat prior follows from the requirement that the “predictive” distribution P(n) be independent of n. And that condition is from the requirement that in the absence of any data there be no a priori reason to favor any value for n. Then a flat P(r) results from the following argument.

The integral of (1.23) over r is unity, so that P(n) is

$$P ( n ) = \int P ( r ) P ( n \vert r , T ) d r = \frac{1}{n !} \int P ( r ) {( rT )}^{n} {e}^{- rT} d r \qquad ( 1.24 )$$

If P(r) is independent of r from 0 to rᵤ the right hand side integral is ∝(rT)ⁿ e^{-rT}dr=n!/T, so long as rᵤT>>n. Then P(n)=1/rᵤT, and is independent of n. Any r dependence of P(r) would cause an n dependence of P(n). Thus a flat P(r) and a flat P(n) go together.

Putting the now known (or assumed) three factors in the right hand side of (1.23), find

$$P ( r \vert n , T ) = \frac{{T ( rT )}^{n}}{n !} {e}^{- rT} , \qquad ( 1.25 )$$

independent of rᵤ. P(r|n,T)dr is the probability that the mean rate (cts/sec) is in [r, r+dr] given T and the measured number of counts n. It is also the probability that the mean number of counts in T is rT. Eq (1.25) is a general expression for the probability of the mean rate inferred from measured counts. It is just T times the Poisson distribution. Eq (1.25) is a simple form of what is known as the Gamma Distribution, a standard probability distribution occurring commonly in the theory of waiting times within a Poisson process.

Measurements give us the integral numbers of counts N_{off} and Nₒₙ and the times T_{off} and Tₒₙ. But for the radiation detector example, the radioactive isotope source does emit at some mean rate, providing a mean source count rate s (counts/sec). The source emission rate is characteristic of the source, its count rate s is characteristic of the source-plus-detector, while measured numbers are characteristic of the radiation detection. It will be useful to obtain probability distributions for both rates and counts.

We now address the radiation detection isotope identification problem. We measure the radiation background for a time T_{off} obtaining N_{off} detected photon counts. And we measure detector exposure to the isotope source, or on-source, for Tₒₙ obtaining Nₒₙ counts, which include both background radiation and a possible radioactive isotope source of interest.

It is necessary to determine the probability that, among the Nₒₙ counts, i of them are source counts, and the probability distribution p(s) that the mean source count rate is s.

Let b be the mean background rate (to be determined, but assumed to be the same during T_{off} and Tₒₙ), and b+s the mean rate during the on-measurement (also to be determined). Then P(b|N_{off}) stands for the probability that the background count rate is b, given the off-measurement. Similarly P(b+s|Nₒₙ) is the probability that the mean on-rate is b+s during the on-measurement, given Nₒₙ. More generally, P(bs|N_{off} Nₒₙ) stands for the joint probability that the background rate is b and the source rate is s, given N_{off} and Nₒₙ (and T_{off} and Tₒₙ).

Two cases are worth considering. The first case is when the background has been well measured with many counts, and its mean rate b can be considered known. The probability distribution p(s) for the mean source count rate s is described by [Eq (1.27)], and the probability χᵢ that the number of source counts is i [Eq (1.30)]. The second case is for known N_{off} and T_{off} and do not reduce background measurements to a known rate. We will get the s distribution [Eq(1.39)], and the probability Cᵢ that the number of source counts is i [Eq(1.40)].

The measurement of a known mean background, plus source, during Tₒₙ fits the conditions of Eq (1.25), and so

$$P ( b + s \vert {N}_{on} ) = \frac{{{T}_{on} ( ( b + s ) {T}_{on} )}^{{N}_{on}}}{{N}_{on} !} {e}^{- ( b + s ) {T}_{on}} , \qquad ( 1.26 )$$

If background itself had been measured for a long time T_{off} obtaining very many counts N_{off}, the mean background rate b is well approximated by b=N_{off}/T_{off}, with relatively small Poisson standard deviation. Then b is known in (1.26), and it becomes an equation for s alone:

$$p ( s ) ≡ P ( s \vert {N}_{on} ) = D \frac{{{T}_{on} ( ( b + s ) {T}_{on} )}^{{N}_{on}}}{{N}_{on} !} {e}^{- ( b + s ) {T}_{on}} \\ ( b considered known ) \qquad ( 1.27 )$$

P(s|Nₒₙ)ds is the probability that the mean source rate is in [s, s+ds] given b, Nₒₙ, and Tₒₙ. s can be any value 0<s<∞. Eq (1.26) is normalized to unit integral on 0<b+s<∞, so p(s) must be renormalized for b<b+s<∞. Thus the constant D is given by

$$\begin{matrix}{D}^{- 1} = {\int }_{0}^{∞} d s \frac{{{T}_{on} ( ( b + s ) {T}_{on} )}^{{N}_{on}}}{{N}_{on} !} {e}^{- ( b + s ) {T}_{on}} \\ = {\sum }_{j = 0}^{{N}_{on}} \frac{{( {bT}_{on} )}^{j}}{j !} {e}^{- {bT}_{on}}\end{matrix} \qquad ( 1.28 )$$

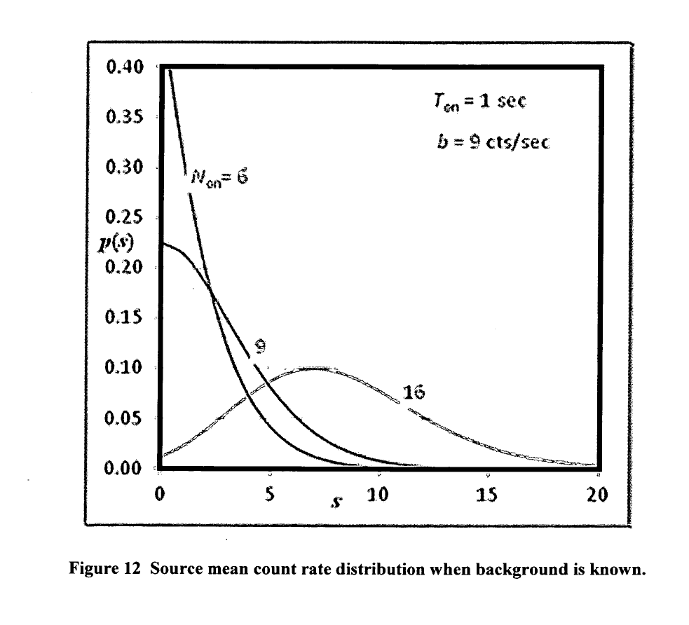

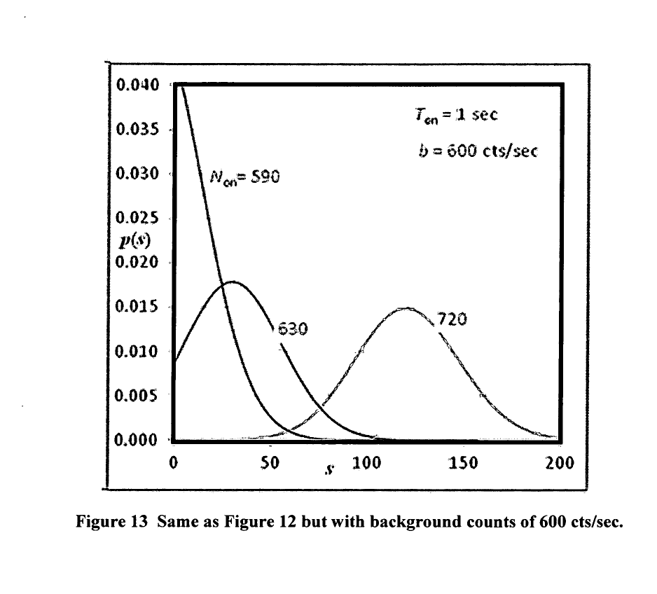

FIGS. 12 and 13 shows examples of radiation photon detection. For the low value b=9 (cts/s), FIG. 12 shows p(s) for Nₒₙ=6, 9, and 16 counts in Tₒₙ=1 sec. For the high rate b=600, FIG. 13 shows p(s) for Nₒₙ=590, 630, and 720 counts. When Nₒₙ/Tₒₙ is less than b, as when Nₒₙ=6 (or 590), the most probable rate is near s=0. The 720 case shows the distribution is becoming Gaussian.

We get the distribution of source counts by expanding the factor ((b+s)Tₒₙ)^{N}^{ₒₙ} in (1.27)

$$\begin{matrix}p ( s ) = D \frac{{T}_{on}}{{N}_{on} !} {e}^{- ( b + s ) {T}_{on}} {\sum }_{i = 0}^{{N}_{on}} ( \begin{matrix}{N}_{on} \\ i\end{matrix} ) {( {bT}_{on} )}^{{N}_{on} - i} {( {sT}_{on} )}^{i} \\ = {\sum }_{i = 0}^{{N}_{on}} {χ}_{i} \frac{{{T}_{on} ( {sT}_{on} )}^{i}}{i !} {e}^{- {sT}_{on}}\end{matrix} \qquad ( 1.29 )$$

where

$$( \begin{matrix}N \\ i\end{matrix} ) = N ! / i ! ( N - i ) !$$

is the binomial coefficient, and

$${χ}_{i} = \frac{1}{ϕ} \frac{{( {bT}_{on} )}^{{N}_{on} - i}}{( {N}_{on} - i ) !} ( b considered known ) \\ where \\ ϕ = {\sum }_{j = 0}^{{N}_{on}} \frac{{( {bT}_{on} )}^{j}}{j !} \qquad ( 1.30 )$$

At this point χᵢ is merely notation, but it is purposely defined so that in (1.29) the factor multiplying χᵢ is P(s|i,Tₒₙ) of Eq (1.25).

However, there is another representation for p(s). During Tₒₙ, any number of counts from 0 to Nₒₙ may be source counts. If i counts are from the source, the probability that the mean source rate is s is just P(s|i, Tₒₙ) from (1.25). Let P(i) be the sought after probability of getting i source counts. Then the complete probability p(s) that the mean source rate is s can be written

$$p ( s ) = {\sum }_{i = 0}^{{N}_{on}} P ( i ) P ( s \vert i , {T}_{on} ) \qquad ( 1.30 )$$

Comparing (1.31) with (1.29) shows that the probability P(i) that i counts are due to the source is χᵢ. Note Σᵢ₌₀^{N}^{ₒₙ}χᵢ=1 as it must.

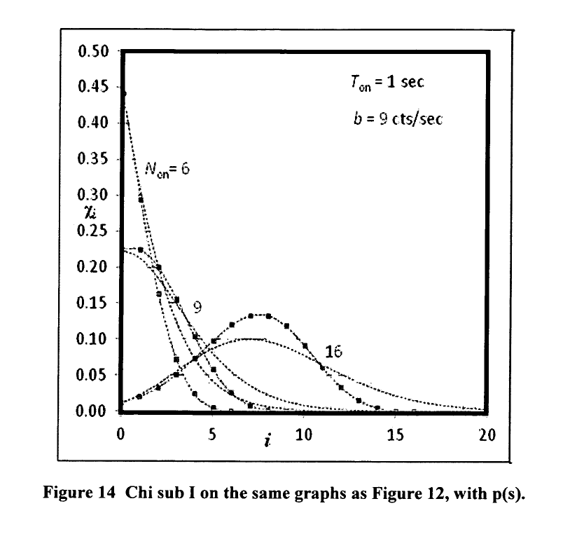

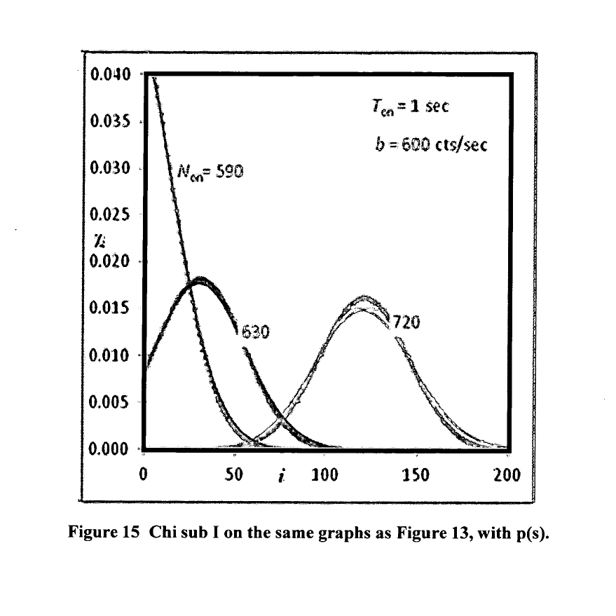

p(s) in FIGS. 14 and 15 shows x, in dots on the same plot. While 0<s<∞, i is limited of course to 0≦i≦Nₒₙ. For low background, b=9, FIG. 14 shows χᵢ departs quite a bit from p(s). p(s) is normalized to unit integral; and since s can exceed Nₒₙ, the maximum of p(s) is less than the maximum of χᵢ, so the χᵢ distribution is generally narrower. FIG. 15, for b=600, shows that same behavior, except that p(s) and χᵢ agree more closely. The mean number of counts due to background is approximately bTₒₙ, so Nₒₙ−bTₒₙ is a first measure of the number due to the source (or 0 if Nₒₙ−bTₒₙ<0). When Nₒₙ−bTₒₙ is itself large (as in the Nₒₙ=720 curve), the shape of both p(s) and χᵢ approach Gaussian (a consequence of the Central Limit Theorem).

For the second case, we do not assume a value for b, but stay with the measured N_{off} and T_{off}. We develop an expression for the probability of a mean source rate, p(s), and the probabilities Cᵢ that exactly i counts are from the source, i=0, 1, . . . , Nₒₙ.

In the unknown mean background rate case, the measurement of background itself during T_{off} fits the conditions of Eq (1.25), and so

$$P ( b \vert {N}_{off} ) = \frac{{{T}_{off} ( {bT}_{off} )}^{{N}_{off}}}{{N}_{off} !} {e}^{- {bT}_{off}} , \qquad ( 1.32 )$$

P(b|N_{off})db is the probability the mean background rate is in [b, b+db]. Now consider the joint probability P(bs|N_{off}Nₒₙ). Separate bs and Nₒₙ using Bayes' Theorem to write it as

$$P ( bs \vert {N}_{off} {N}_{on} ) = P ( bs \vert {N}_{off} ) \frac{P ( {N}_{on} \vert {bsN}_{off} )}{P ( {N}_{on} )} \qquad ( 1.33 )$$

Since b is considered the same during T_{off} and Tₒₙ, the prior factor here is

P(bs|N_{off})=P(s|bN_{off})P(b|N_{off}) (1.34)

Now s has nothing to do with b and N_{off}, so P(s|bN_{off}) is just P(s). In its role as the prior in (1.33), it may be taken to be a constant (P(s|Nₒₙ), however, is not a constant), over some suitable, large range of s. Its value, and the range, will drop out, so for simplicity we can let P(s)=1. The second factor in (1.34) is just (1.32).

The likelihood function in (1.33), that is, the factor P(Nₒₙ|bsN_{off}), is the Poisson probability of getting Nₒₙ counts when the mean number is (b+s)Tₒₙ[T_{off} and Tₒₙ are considered known, but are not explicitly displayed as arguments in P(Nₒₙ|bsN_{off})]. Putting these factors together, we have

$$\begin{matrix}P ( bs \vert {N}_{off} {N}_{on} ) = AP ( b \vert {N}_{off} ) P ( {N}_{on} \vert {bsN}_{off} ) \\ = A \frac{{{T}_{off} ( {bT}_{off} )}^{{N}_{off}}}{{N}_{off} !} {e}^{- {bT}_{off}} \frac{{( ( b + s ) {T}_{on} )}^{{N}_{on}}}{{N}_{on} !} \\ {e}^{- ( b + s ) {T}_{on}}\end{matrix} \qquad ( 1.35 )$$

The denominator P(Nₒₙ) is absorbed into a normalization constant A. From this joint probability the distribution of s itself is obtained by integrating out (“marginalizing”) the b variable:

$$P ( s \vert {N}_{off} {N}_{on} ) = \int d bP ( bs \vert {N}_{off} {N}_{on} ) = A \frac{{T}_{on}^{{N}_{on}} {T}_{off}^{{N}_{off} + 1}}{{N}_{on} ! {N}_{off} !} {e}^{- {sT}_{on}} \int d {b ( b + s )}^{{N}_{on}} {b}^{{N}_{off}} {e}^{- b ( {T}_{on} + {T}_{off} )} \qquad ( 1.36 )$$

Now expand

$${( b + s )}^{{N}_{on}} = {\sum }_{i = 0}^{{N}_{on}} ( \begin{matrix}{N}_{on} \\ i\end{matrix} ) {b}^{{N}_{on} - i} {s}^{i} \qquad ( 1.37 )$$

and use

$$\int d {bb}^{{N}_{on} - i + {N}_{off}} {e}^{- b ( {T}_{on} + {T}_{off} )} = \frac{\int d {uu}^{{N}_{on} - i + {N}_{off}} {e}^{- u}}{{( {T}_{on} + {T}_{off} )}^{{N}_{on} - t + {N}_{off} + 1}} = \frac{( {N}_{on} - i + {N}_{off} ) !}{{( {T}_{on} + {T}_{off} )}^{{N}_{on} - i + {N}_{off} + 1}} \qquad ( 1.38 )$$

so that (1.36), the probability that the source mean count rate is s (counts/sec), is

$$\begin{matrix}p ( s ) ≡ P ( s \vert {N}_{off} {N}_{on} ) = A \frac{{T}_{on}^{{N}_{on}} {T}_{off}^{{N}_{off} + 1}}{{N}_{on} ! {N}_{off} !} {\sum }_{i = 0}^{{N}_{on}} ( \begin{matrix}{N}_{on} \\ i\end{matrix} ) \frac{i ! ( {N}_{on} - i + {N}_{off} ) !}{{( {T}_{on} + {T}_{off} )}^{{N}_{on} - i + {N}_{off} + 1} {T}_{on}^{i + 1}} \frac{{{T}_{on} ( {sT}_{on} )}^{i} {e}^{- {sT}_{on}}}{i !} ≡ {\sum }_{i = 0}^{{N}_{on}} {C}_{i} \frac{{{T}_{on} ( {sT}_{on} )}^{i} {e}^{- {sT}_{on}}}{i !} \\ where & ( 1.39 ) \\ {C}_{i} = \frac{1}{η} \frac{( {N}_{on} - i + {N}_{off} ) !}{( {N}_{on} - i ) !} {( 1 + \frac{{T}_{off}}{{T}_{on}} )}^{i} , \\ and \\ η ≡ {\sum }_{j = 0}^{{N}_{on}} \frac{( {N}_{on} - j + {N}_{off} ) !}{( {N}_{on} - j ) !} {( 1 + \frac{{T}_{off}}{{T}_{on}} )}^{j} & ( 1.40 )\end{matrix}$$

Nₒₙ−i is the number of background counts during Tₒₙ. As was the case in (1.29), at this point Cᵢ is merely notation, but it is purposely defined so that in (1.39) the factor multiplying Cᵢ is P(s|i,Tₒₙ) of (1.25).

Again, there is another representation for P(s|N_{off} Nₒₙ). Following the argument after (1.29), let P(i) again be the sought after probability of getting i source counts. Then the complete probability P(s|N_{off} Nₒₙ) that the mean source rate is s can be written

$$p ( s ) ≡ P ( s \vert {N}_{off} {N}_{on} ) = {\sum }_{i = 0}^{{N}_{on}} P ( i ) P ( s \vert i , {T}_{on} ) \qquad ( 1.41 )$$

the same as (1.31). Comparing (1.39) with (1.41) shows that the probability P(i) that i counts are due to the source is Cᵢ. Note Σᵢ₌₀^{N}^{ₒₙ} Cᵢ=1 as it must.

The distribution Cᵢ is the best one can infer about the source, knowing only measured numbers and the Poisson statistics of the counts. It is not Poisson or any conventional distribution. When the Cᵢ from (1.40) are inserted in (1.39) one obtains a closed expression for the probability p(s) that the source mean count rate is s. The resulting expression is not especially illuminating, so we merely present examples below.

The only difference between χᵢ and Cᵢ is that χᵢ is the probability when b is considered known (along with Nₒₙ and Tₒₙ) (if b is not known from some other measurement, it can nominally be taken to be N_{off}/T_{off}), while Cᵢ is the probability when N_{off}, T_{off}, Nₒₙ, and Tₒₙ are the only known's.

We have considered the measured total counts (over all emitted isotope energies), but one can confine attention to individual radiation detector energy bins; the Cᵢ apply to the number of counts in each bin as well.

For large Nₒₙ or N_{off}, the factorials in (1.40) for Cᵢ can become enormous, beyond the limits of most software computational packages. Fortunately (1.40) can be cast into a more convenient form which is easy to evaluate. Define the fractions of on-time and off-time of the total measurement time Tₒₙ+T_{off}:

$${f}_{on} = \frac{{T}_{on}}{{T}_{on} + {T}_{off}} , \\ \begin{matrix}{f}_{off} = \frac{{T}_{off}}{{T}_{on} + {T}_{off}} \\ = 1 - {f}_{on}\end{matrix} \qquad ( 1.42 )$$

Cᵢ is separately normalized, so we may multiply by any non i-dependent factors and renormalize later. In particular, divide by N_{off}! to obtain

$${C}_{i} = \frac{( {N}_{on} - i + {N}_{off} )}{( {N}_{on} - i ) ! {N}_{off} !} {f}_{on}^{- i} \qquad ( 1.43 )$$

Then multiply by fₒₙ^{N}^{ₒₙ} f_{off}^{N}^{_{off}} and renormalize, obtaining

$$\begin{matrix}{C}_{i} = \frac{1}{ζ} ( \begin{matrix}M \\ {N}_{off}\end{matrix} ) {f}_{on}^{{N}_{on} - i} {f}_{off}^{{N}_{off}} \\ where & ( 1.44 ) \\ M ≡ {N}_{on} - i + {N}_{off} , \\ and \\ ζ = {\sum }_{i = 0}^{{N}_{on}} ( \begin{matrix}M \\ {N}_{off}\end{matrix} ) {f}_{on}^{{N}_{on} - i} {f}_{off}^{{N}_{off}} . & ( 1.45 )\end{matrix}$$

M is the total number of background counts during T_{off}+Tₒₙ, and depends, of course, on i. Since Nₒₙ−i=M−N_{off}, Cᵢ is the N_{off}-th term in the binomial expansion of 1=(f_{off}+fₒₙ)^{M}.

Since i is in M, not in N_{off}, the normalizing sum ζ has no obvious closed expression. But each Cᵢ is a small number, and the sum is computed. It is best to analytically find the i corresponding to the largest Cᵢ, and evaluate that term and adjacent terms one by one, until distant terms are negligibly small.

To identify signatures from mixtures of candidates, the sensor may observe a source signal from a mixture instead of a single source from the library plus background. The SSI Method can handle this case.

Mixtures of isotopes can be analyzed by the SSI Method. Again with the radioactive isotope identification example, assume a source is composed of nᵢ isotope components that are the Source; consider without loss of generality, that the number of isotopes is equal to 2 but can be as large as the whole library if need be. If nᵢ=2, then two isotopes will be combined in an unknown ratio that will contribute to the measured signal at the detector. The count contributions will be in proportion to the count rate from each isotope in the mixture. Background rates will be unaffected. The signature library contains the probability density distributions for each source candidate but does not contain any mixtures. The ratio of isotopes in the mixture signal is a parameter (or set of parameters) that must be determined.

We define a metric that tells us what is the most likely mixture of any individual isotopes in the library that create a given measured signal count spectrum. The decision metric for isotope identification is a quantitative value that a given mixture for a given combination is an absolute maximum. This maximum probability is important when considering isotope mixtures that have different shielding (signal attenuation due to materials between the source and the radiation detector) from the isotopes in the combination mixture, but the same source ID. That is, the approach will let us handle different shielding of a single isotope type. There is more than one decision metric that can give us the best mixture estimate. We choose maximum probability for a mixture combination.

Looking at the two isotope mixes from the 14 isotope library, there will be 91 combination mixtures, i.e. the combination of 14 isotopes taken at 2 at a time. If the 14 were taken at 3 at a time, there would be 364 combinations, 4 at a time there would be 1001 combinations. Of these mixtures, there is a continuous spectrum of mixture ratios. The maximum probabilities are fairly smooth functions of the mixture ratio. This affords straightforward search for the maximum as a function of the mixture ratios.

As example, isotope 1 has contribution fraction of counts f₁ and isotope 2 has contribution f₂, and background has contribution f_{B}. The probability density of the mixture is then given as composite of the probability densities for each isotope:

Pₘᵢₓ=f₁·P₁+f₂·P₂+f_{B}·P_{b} (1.46)

Where P₁, P₂ and P_{B} are the isotope instrument probability density bin distributions for isotopes 1, 2 and background respectively. They are pre-computed or extensively measured and are very well known for a given detector and measurement scenario geometry. The count value of the fractions f₁ and f₂ comes from the source mixture ratio of source measured counts to total background plus source measurements, Non. The value of f_{B} comes from the long-term background measurement when source 1 and 2 mixture is not present. Thus the value of mixture fraction f₁+f₂ is given as

$$\begin{matrix}{f}_{1} + {f}_{2} = \frac{{C}_{1}}{Non} + \frac{{C}_{2}}{Non} = \frac{{C}_{S}}{Non} \\ = {f}_{mix}\end{matrix} \qquad ( 1.47 )$$

Where C₁ is the counts from isotope 1 and C₂ is the counts from isotope 2 and Non is the total measured counts in time Ton when the mixture and the background is present, i.e., the radiation detector is measuring the isotope mix. It is also reasonable that the total source counts C_{S}=C₁+C₂ are distributed as the “Cᵢ” source counts from Equation (1.44). The value of i can take on values from 0 to Non. The value of f₁ and f₂ are independent free parameters that add up to fₘᵢₓ. A new parameter set can be introduced for convenience, q₁ and q₂. These new parameters are defined to add to one. The f parameters are defined to relate to the q₁ and q₂ parameters as

$${q}_{1} = \frac{{f}_{1}}{{f}_{mix}} , \\ {q}_{2} = \frac{{f}_{2}}{{f}_{mix}} \\ {q}_{1} + {q}_{2} = 1. \qquad ( 1.48 )$$

The probability density for a mixture in terms of the q₁ and q₂ parameters is then given as

$${P}_{mix} = {q}_{1} \frac{{C}_{S}}{Non} {P}_{1} + {q}_{2} \frac{{C}_{S}}{Non} {P}_{2} + ( 1 - \frac{{C}_{S}}{Non} ) {P}_{B} \qquad ( 1.49 )$$

This equation can be generalized to more than two components in the source mixture. The free parameters, q₁ and q₂, are independent variables, and their values define the isotope mixtures; the q's, are adjusted to give the largest value of the probability for library isotope 1 and 2 mix for every possible isotope combination mix in the library. For N isotopes in the library, taken k at a time, the number calculated combination probabilities will be

$$( \begin{matrix}N \\ k\end{matrix} ) = \frac{N !}{k ! ( N - k ) !} \qquad ( 1.50 )$$

which is 91 when N=14 and k=2. This discussion can be generalized to k larger than 2.

The SSI Method calculates the probability for every isotope combination for a mixture spanning ratio range of 20 equally spaced values of the q's. The selected q's that give the maximum probability among all the of isotope combinations is chosen as the combination that best represents the measured data. This is the maximum probability as a function of q's of all the maxima of the combinations. The value of the q's determines the partition of the probability densities among isotopes and the fraction of counts coming from a given isotope in the combination. The mix combination that gives the maximum probability is chosen as the most likely contributor to the measurement. This decision result is stochastic and may change for different measurement realizations, though the estimated combination and mix ratio is usually the same for each realization even for sparse counting measurements.

The variation of the maximum probabilities for isotopes is generally a smooth peaked function of q's. We can loop over a rough spacing of q's say twenty or so. We in general loop over the 20 q₁ values that range from 0% of source contribution to 100 percent of contribution in 20 steps. For each of q's, the calculation loops over every isotope

$$( \begin{matrix}N \\ k\end{matrix} )$$

combination for N isotopes in the library taken k at a time.

To calculate the probability of a combination of isotopes resulting in the measured source signal, we calculate the estimated probability density of the mixture combination. The probability density per bin for the mixture for isotope 1, 2 and background is proportioned among the isotopes. Equation (1.49) gives the mixture probability density for the combination. This is the instrument response function for the mixture of isotopes and background.

To sample the source distribution, we change the source counts across the most probable count values for every possible count value. The maximum source count distribution is taken as Non-N_{off} which is greater than zero and less than Nₒₙ. This means the estimated source counts can vary from 0 to Non. For each source count estimate Cₛ between 0 and Non, the instrument response function of the mixture is generated, that is, the mixture probability density given by

$${P}_{mix} = {q}_{1} \frac{{C}_{s}}{{N}_{on}} {P}_{1} + {q}_{2} \frac{{C}_{s}}{{N}_{on}} {P}_{2} + ( 1 - \frac{{C}_{s}}{{N}_{on}} ) {P}_{B} \qquad ( 1.51 )$$

Where P₁ is isotope 1 probability detector response across 256 bins, P₂ is the isotope 2 probability detector response across 256 bins; P_{B} is similar probability for background. The q's are independent parameters to be determined. When k=2, the q₁ is related to q₂ and there is only one independent parameter.

The distribution for the probability of the Cₛ is known and that distribution function is used to weight the calculated probability for a given combination of isotope pairs. The probability for each of these samples from the probability density of estimated Cₛ then weights the calculated probability. The posterior probability is calculated using the measured bin count data and instrument response probability density mixture as the most likely distribution for the Pₘᵢₓ. This probability is actually a Multinomial Probability across all bin counts. The iterative probability with flat priors is a multinomial probability.

$$P = \frac{N !}{{n}_{1} ! {n}_{2} ! … {n}_{256} !} {p}_{mix 1}^{{n}_{1}} {p}_{mix 2 }^{{n}_{2}} … {p}_{mix 256}^{{n}_{256}} \qquad ( 1.52 )$$

Where P is the probability that counts in bins 1 through 256 come from a mixture with probability density distribution pₘᵢₓ₁, pₘᵢₓ₂, . . . , pₘᵢₓ₂₅₆. Because numbers can become enormous in probability space, we work in log probability space. The probability is found for every combination and every concentration ratio; the probabilities are then normalized by the maximum probability. This leads to maximum probabilities for every source combination, and every concentration ratio.

The source count distribution is determined from the source count spectrum (C_{S}), the Nₒₙ, N_{off}, Tₒₙ, and T_{off}. The source count distribution is given from

$${C}_{i} = \frac{1}{η} \frac{( {N}_{on} - i + {N}_{off} ) !}{( {N}_{on} - i ) !} {( 1 + \frac{{T}_{off}}{{T}_{on}} )}^{i} , \\ where \\ η ≡ {\sum }_{j = 0}^{{N}_{on}} \frac{( {N}_{on} - j + {N}_{off} ) !}{( {N}_{on} - j ) !} {( 1 + \frac{{T}_{off}}{{T}_{on}} )}^{j} \qquad ( 1.53 )$$

And where Nₒₙ is the source plus background counts, N_{off} is the background counts collected in T_{off} time; i is the counts in the spectrum, η is the normalization of the Cᵢ distribution, which makes it a true probability distribution. The combination probabilities will be weighted by the probability density calculated from the distribution of the Cᵢ. Once this array of probabilities is calculated for each sample of the sources, the entire array is normalized by the maximum probability in the full array (91×20). These probabilities are used to find a single weighted average. The weighting values are the normalized source distribution probabilities. The free parameters are adjusted using the Levenberg-Marquardt algorithm or other suitable non-linear least squares minimization technique to find the q values of the maximum probability for each combination of sources. This forms a probability array that can be

$$( \begin{matrix}N \\ k\end{matrix} )$$

x m values and each value in the array has a set of q's that give the fraction of the sources in the mix, m is the 20 equally spaced concentration ratios. The combinations rapidly drive the calculation time for large spanning sets and complex mixtures.

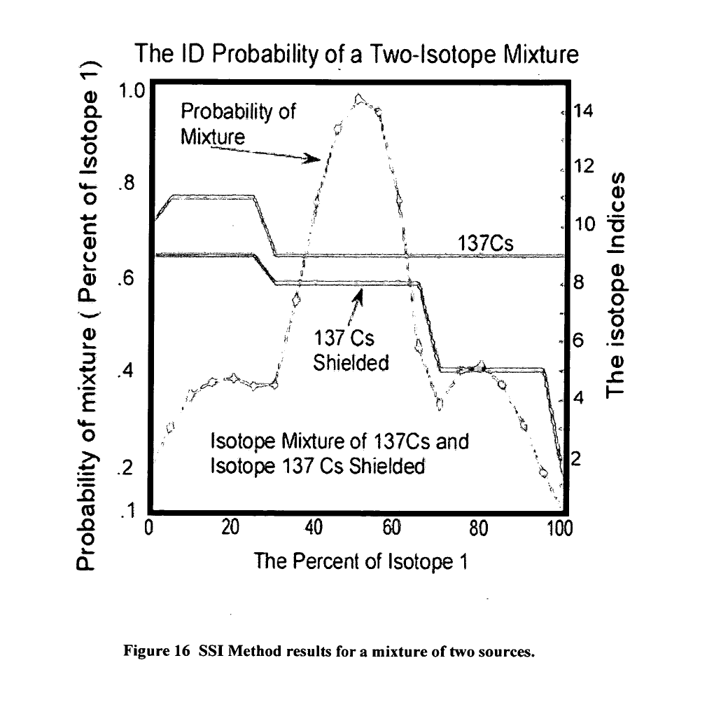

For a single measurement, the analysis results can be presented as seen in FIG. 16.

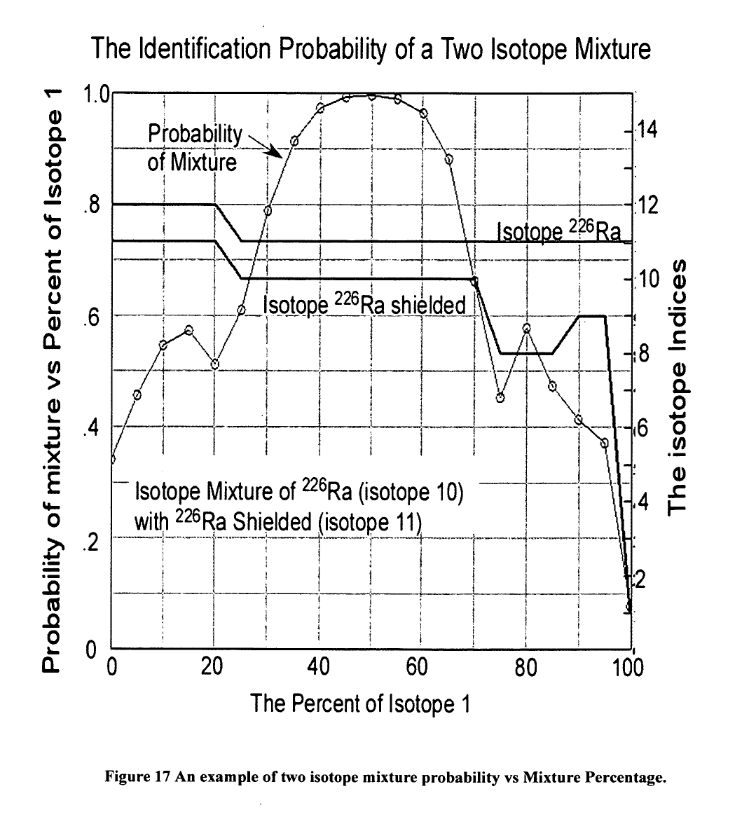

The figure shows the SSI Method results for a single synthetic measurement of two isotopes with 50/50 q mix of isotope 8 and isotope 9 (Cs137 Bare and Shielded) for the case where the background was 961 counts, the total counts with signals plus background was 1023 counts. The flat straight lines are the indices of the isotope with the largest probability for a given q₁ ratio. The maximum probability occurred for q₁=0.5 for isotope 8 and isotope 9. The analysis correctly finds the probability maximum from all combinations as coming from the combination of 8 and 9. The maximum occurs at the 50 percent of isotope #8. Other smaller relative maxima occur but are giving incorrect isotopes and mix ratios. In this example, the maximum probability occurs for the correct combination of isotopes near q₁=0.5. The relative mix of the isotopes is the value used to generate the synthetic measurement. FIG. 17 shows similar analysis results for isotopes 10 and 11 (Ra226 bare and Ra226 shielded), which have very similar spectra.

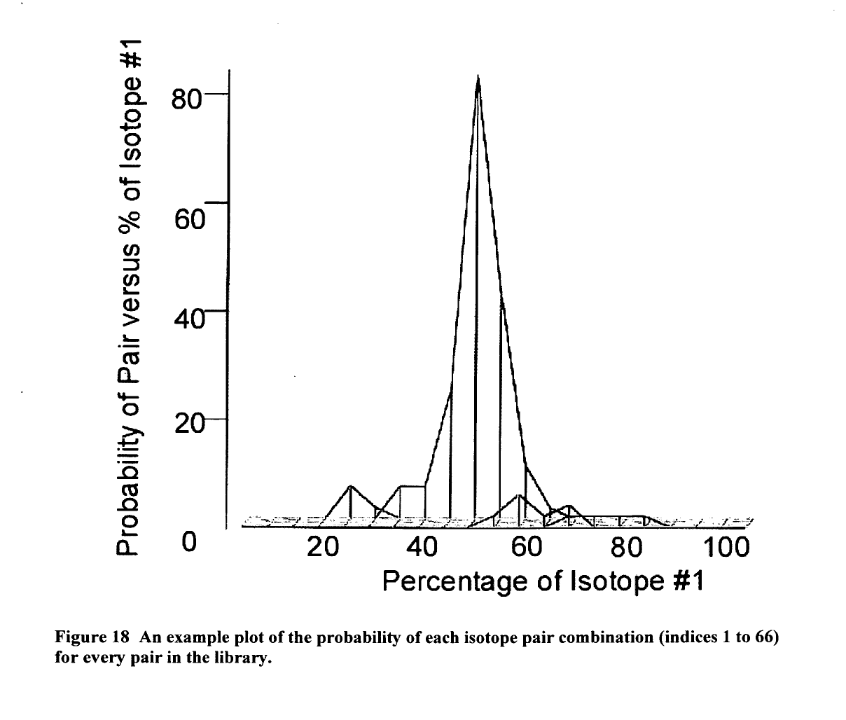

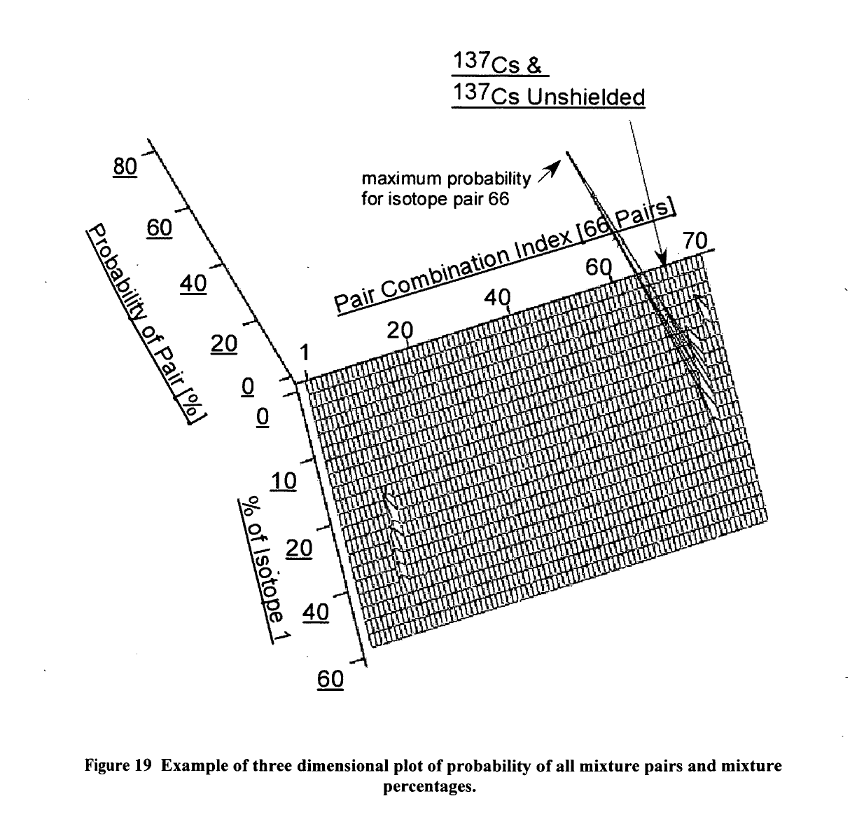

The process results shown in FIGS. 16 and 17 can be automated by searching for the q's with the maximum probability using a damped non-linear least squares methodology such as using a Levenberg-Marquardt methodology. The presentation then is the isotope indices, the ratios of concentrations and the maximum probability. The process results shown in FIGS. 16 and 17 can be repeated with over 100 measurement realizations with the same sparse gross count values of background and signal and measured spectrum. The total binning of results give a confidence of the mixture identification. The synthetic measurement realizations are generated by sampling the probability densities with a specified set of q values. These realizations are then analyzed with the SSI Method. Typical results for two orientations of the 3D plot for 100 trials are shown in FIGS. 18 and 19. FIG. 18 shows a straight-on orientation, and FIG. 19 a top view, of the probability versus isotope concentration ratio and versus isotope combination pair out of 91 candidates. The maximum probability is distinct and indicates the mixture pair and the ratio of isotope 1 to isotope 2 that created the synthetic signature. For cases where k is greater than 2, graphical representation becomes cumbersome with multiple 3D plots required.

What is claimed is:

1. A method of processing a statistically sparse, low signal to noise, or undersampled signature data set to identify the source using a process consisting of Bayesian analysis, multinomial analysis, probability theory, and regressive covariance techniques; the method comprising:
a. capturing and identifying a source data set for analysis using a sensor system;
b. capturing a background data set for analysis by means of a sensor; and
c. analysis of a model or of actual source data for each of the candidate sources in a library using a computing device.

2. The method of claim 1 which includes the computing of probability density functions from the captured data sets.

3. The method of claim 1 which includes the computing of prior probability density functions for each candidate of the possible sources.

4. The method of claim 1 which includes the computing of signal likelihood estimates for each candidate.

5. The method of claim 1 which includes the computing of posterior probabilities for each candidate of the possible sources library.

6. The method of claim 1 which includes the computing of a covariance confidence level of the signal identification.

7. The method of claim 1, wherein the data is processed to identify a single source amongst numerous candidates under consideration.

8. The method of claim 1, wherein the data is processed to identify a mixture of two or more sources amongst numerous candidates under consideration.

9. The method of claim 1, wherein data is processed using maximum likelihood over candidate mixes of background and source, with no explicit subtraction of the background.

10. The method of claim 1, wherein the signal plus background is a sparser data set than that observed in the independent background measurement.

11. The method of claim 1, wherein the rankings of the candidate source propositions are assigned well before there is statistically robust data collected in the measurement to allow identification by any identification method based on geometric shape, individual features, or overall distribution.

12. The method of claim 1, wherein the source is identified with a corresponding confidence level of correct identification.

13. The method of claim 1, wherein the sources are identified with corresponding individual confidence levels of correct identification.
